(19) United States
(12) Patent Application Publication
(10) Pub. No.: US 2015/0276095 A1
(43) Pub. Date: Oct. 1, 2015

(54) MULTI-SECTION LENGTH OF PIPE AND ASSOCIATED METHODS FOR MAKING THE SAME

(71) Applicant: D AND D MANUFACTURING, TITUSVILLE, FL (US)

(72) Inventors: Dale E. POLK, JR., TITUSVILLE, FL (US); TIMOTHY A. POLK, TITUSVILLE, FL (US)

(21) Appl. No.: 14/672,753

(22) Filed: Mar. 30, 2015

Related U.S. Application Data
(60) Provisional application No. 61/972,751, filed on Mar. 31, 2014.

(51) Int. Cl. F16L 9/22; F16L 9/128

(52) U.S. Cl. CPC F16L 9/22; F16L 9/128

(57) ABSTRACT

A pipe includes a number of pipe sections extending in a longitudinal direction. Each pipe section includes a radially outward circumferential surface area extending in the longitudinal direction to define an exterior surface. The radially outward circumferential surface area has a pair of opposing side edges extending in the longitudinal direction, with one of the side edges having a recess and with the other side edge having a tab. Adjacent pipe sections are joined together by inserting the tab from one of the pipe sections into the recess of an adjacent pipe section so as to form an interlocking joint between the two pipe sections.

### RELATED APPLICATION

This application claims the benefit of U.S. Provisional Application Ser. No. 61/972,751 filed Mar. 31, 2014, the entire contents of which are incorporated herein by reference.

### FIELD OF THE INVENTION

The present invention relates to the field of pipes, and, more particularly, to a length of pipe formed with multiple interlocking sections.

### BACKGROUND OF THE INVENTION

Pipes are used in many different engineering applications. For example, pipes are used to carry water, gas or other flowable liquid products. Pipes often extend great distances. Pipes are usually laid end-to-end and secured together when extended over great distances.

For ease of installation and to minimize the number of joint connections in the pipes, the pipes are made as long as possible. Depending on the size of the truck or shipping container, typical pipe lengths may be about 14 to 60 feet long. The longer and heavier a pipe is means that the equipment used to support and guide the pipe during installation is more complex.

For applications where the liquid or gas is at a high temperature and under pressure, concrete or steel pipes are used. A disadvantage of concrete or steel pipes is that they are very heavy, and as a result, can be difficult to handle and costly to ship. Many times the cost to ship concrete or steel pipes can exceed the cost of the pipes themselves.

For some applications, PVC pipes may be used. PVC pipes may be ribbed or corrugated to provide extra strength. Unfortunately, PVC pipes are limited to the amount of pressure they can withstand. In addition, each length of pipe is generally formed as a unitary piece or member which is cast or otherwise formed in any conventional process. Although PVC pipes are significantly lighter than concrete pipes, they still take up the same volume within a truck or shipping container.

As an alternative to a unitary length of pipe, U.S. Pat. No. 1,430,094 to Meier discloses a plurality of elongated sections that are interlocked together to form a length of pipe. Interlocking sections to form the length of pipe allows more lengths of pipe to be shipped in a given volume since the sections may be stacked one on top of another. Lugs are used to lock the sections together. In addition, an additional coupling means may be used to hold the sections together. The Meier patent further discloses that the sections of the pipe are held together by concrete which is poured into the sections to interlock the lugs.

Another length of pipe formed with multiple interlocking sections is disclosed in U.S. Pat. No. 4,296,781 to Magnus. Magnus discloses an elongated sectional pipe formed from a plurality of tubular members connected together end to end. Each tubular member comprises three sections each having a plurality of longitudinally staggered lugs. The lugs have curved locking surfaces and allow the sections to be snapped together. A pipe may be formed by consecutively snapping a plurality of tubular members together from their disassembled sections while simultaneously coupling the tubular members together end to end.

Even in view of the above multi-section pipe lengths, there is still a need to improve upon a length of pipe formed with multiple interlocking sections.

### SUMMARY OF THE INVENTION

A pipe comprises a plurality of pipe sections extending in a longitudinal direction. Each pipe section may comprise a radially outward circumferential surface area extending in the longitudinal direction to define an exterior surface. The radially outward circumferential surface area may have a pair of opposing side edges extending in the longitudinal direction, with one of the side edges having a recess and with the other side edge having a tab. Adjacent pipe sections are joined together by inserting the tab from one of the pipe sections into the recess of an adjacent pipe section so as to form an interlocking joint therebetween.

The recess and tab on the respective opposing side edges of each pipe section may be positioned along an interior surface of each pipe section.

The pipe may further comprise ribbing that circumferentially extends along the exterior surface of each pipe section. In one embodiment, the ribbing may form a rectangular-shaped grid pattern. In another embodiment, the ribbing may form a triangular-shaped grid pattern.

Each side edge may include a plurality of openings extending therethrough, with the plurality of openings between adjacent pipe sections forming the interlocking joint being aligned with one another. The pipe may further comprise a plurality of mechanical fasteners extending through the plurality of openings. In one embodiment, the plurality of mechanical fasteners may comprise rivets. In another embodiment, the plurality of mechanical fasteners may comprise nuts and bolts.

Each pipe section may further comprise a pair of opposing end areas, with the radially outward circumferential surface area extending between the pair of opposing end areas. Each end area may comprise a flange and ribbing adjacent the flange, with the ribbing circumferentially extending along an exterior surface of the end area adjacent the flange.

Each pipe section may further comprise a pair of opposing end areas, with the radially outward circumferential surface area extending between the pair of opposing end areas. One of the end areas may be configured as a slip fit end and the other end may be configured as a bell end, with the slip fit end having a radius less than a radius of the bell end.

The plurality of pipe sections may comprise at least one of 2, 4, 6 and 8 pipe sections. Each pipe section may comprise a thermoplastic material or a thermosetting material.

Another aspect is directed to a method for making the pipe as described above. The method may comprise forming a plurality of pipe sections extending in a longitudinal direction. Each pipe section may comprise a radially outward circumferential surface area extending in the longitudinal direction to define an exterior surface. The radially outward circumferential surface area may have a pair of opposing side edges extending in the longitudinal direction, with one of the side edges having a recess and with the other side edge having a tab. The method may further comprise joining adjacent pipe sections together by inserting the tab from one of the pipe sections into the recess of an adjacent pipe section so as to form an interlocking joint therebetween.

### BRIEF DESCRIPTION OF THE DRAWINGS

FIG. 1 is a perspective view of longitudinally extending pipe sections assembled together to form a length of pipe with flanges in accordance with the present invention.

FIG. 2 is an end view of the assembled length of pipe illustrated in FIG. 1.

FIG. 3 is a perspective view of one of the longitudinally extending pipe sections used to form the length of pipe illustrated in FIG. 1.

FIG. 4 is an end view of the longitudinally extending pipe sections prior to being assembled to form the length of pipe illustrated in FIG. 1.

FIG. 5 is a partial view of the pattern of ribbing illustrated in FIG. 1 with an additional rib diagonally intersecting each grid pattern to provide a triangular shaped grid pattern.

FIG. 6 is a partial view of the pattern of ribbing illustrated in FIG. 1 with two additional ribs diagonally intersecting each grid pattern to provide a multi-triangular shaped grid pattern.

FIG. 7 is a side view of assembled lengths of pipes as illustrated in FIG. 1 being jointed together.

FIG. 8 is a perspective view of another embodiment of the assembled length of pipe illustrated in FIG. 1 with a bell end and slip fit end design.

FIG. 9 is a partial perspective view of assembled lengths of pipes as illustrated in FIG. 8 being jointed together.

FIG. 10 is an enlarged partial perspective view of the assembled lengths of pipes as illustrated in FIG. 9 with a mechanical fastener securing the connection.

FIG. 11 is an adapter coupler used to shorten the length of pipe as illustrated in FIGS. 1 and 8.

FIG. 12 is a perspective view of the length of pipe as illustrated in FIG. 1 formed as a unitary piece.

FIG. 13 is a flowchart illustrating a method for making the pipe as illustrated in FIG. 1.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and multiple notations are used to indicate similar elements in alternative embodiments.

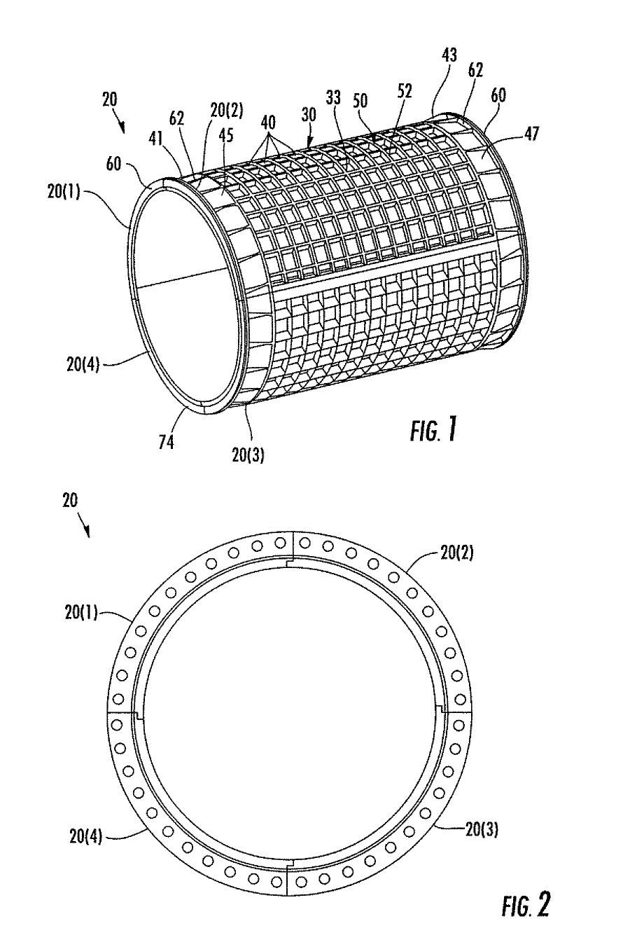

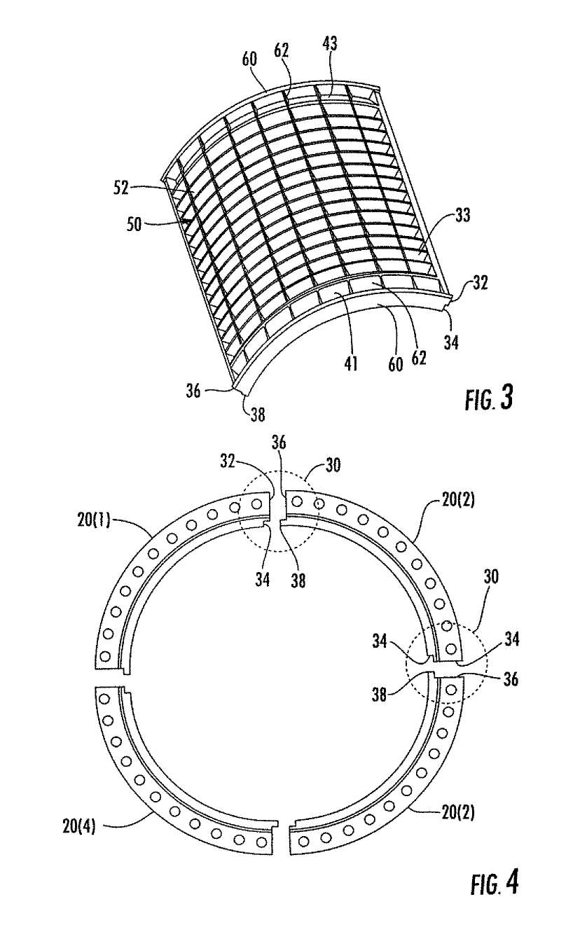

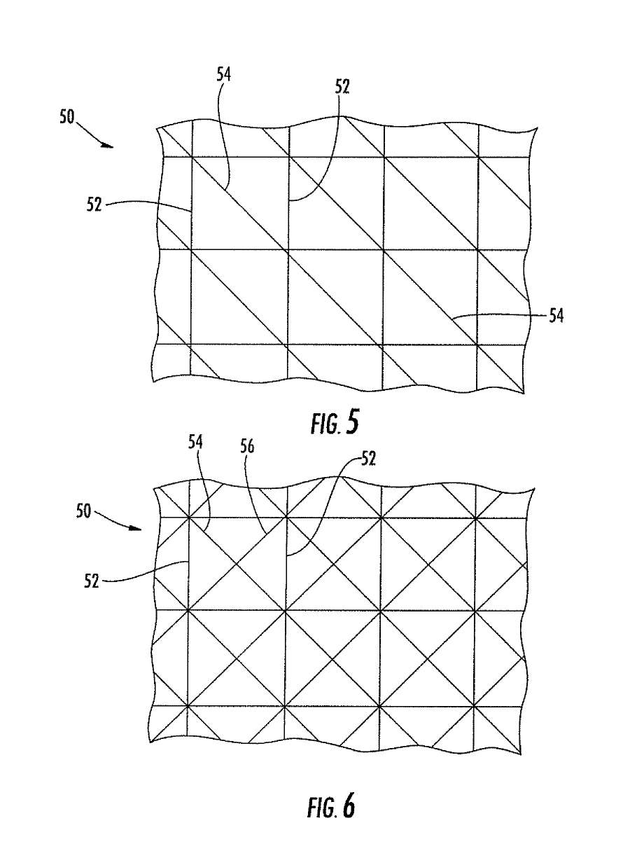

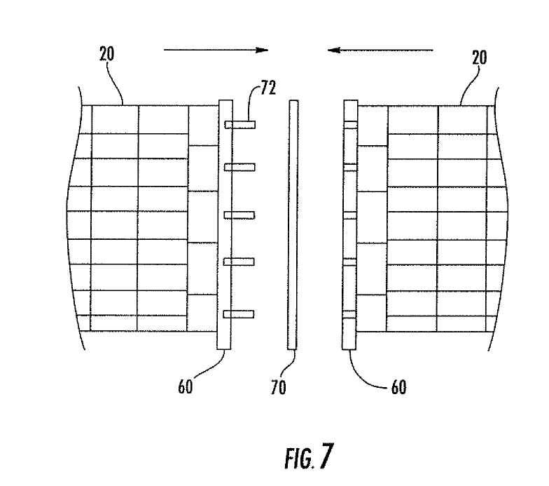

Referring initially to FIGS. 1-4, the illustrated length of pipe 20 comprises a plurality of longitudinally extending pipe sections 22(1), 22(2), 22(3) and 22(4) joined together along a linear dimension of the pipe. Each pipe section 22(1)-22(4) is interlocked with an adjacent pipe section. Each pipe section 22(1)-22(4) includes a radially outward circumferential surface area 33 extending in the longitudinal direction to define an exterior surface. The radially outward circumferential surface area 33 has a pair of opposing side edges 32, 36 extending in the longitudinal direction, with one of the side edges having a recess 34 and with the other side edge having a tab 38.

Adjacent pipe sections 22(1)-22(4) are joined together by inserting the tab 38 from one of the pipe sections into the recess 34 of an adjacent pipe section so as to form an interlocking joint therebetween. In the illustrated embodiment, the recess 34 is on an innermost surface 32 of a pipe section 22(1) and the tab 38 is on an innermost surface 34 of an adjacent pipe section 22(2). Each pipe section 22(1)-22(4) is configured to have both a recess 34 and a tab 38 for forming interlocking joints 30 with adjacent pipe sections.

A solvent glue or adhesive may be used along the recess 34 and the tab 36 to ensure that each interlocking joint 30 is watertight. The glue or adhesive thus helps form a glued seam between adjacent pipe sections.

Once two pipe sections are joined together forming a hemisphere, such as pipe sections 22(1) and 22(2), mechanical fasteners 40 may be added to further strengthen the interlocking joint 30, as illustrated in FIG. 1. The mechanical fasteners 40 extend along the linear length of the interlocking joint 30. The mechanical fasteners 40 may be rivets, for example. Alternatively, the mechanical fasteners 40 may be bolts and nuts. If the openings along the linear interlocking joint 30 are treaded, then bolts may be be used without the need for the nuts.

After the other hemisphere has been formed in the same manner, i.e., pipe sections 22(3) and 22(4) are joined together, and the two hemispheres are then joined together to form a completed length of pipe 20. Again, solvent glue or adhesive may be used along the interlocking joints 30 to ensure that the length of pipe 20 is watertight. Once the two hemispheres are joined together forming the length of pipe 20, mechanical fasteners 40 may be added to further strengthen the interlocking joints 30, as used in forming each hemisphere.

The weight of an assembled length of pipe 20 that is 4 feet in length, for example, and made of a thermoplastic material will be approximately ⅛ the weight of a comparable concrete pipe of the same interior dimension. Even with the increased linear footage of pipe 20 per shipment due to the ability to nest the pipe sections 22(1)-22(4) before assembly the total weight of a shipment will be less than the lesser amount of comparable pipe. The lighter weight of a length of pipe 20 will reduce the need for high load capacity equipment at the location of installation. These weight savings in shipping and installation will save cost.

A pattern of ribbing 50 circumferentially extends along the exterior surface of each radially outward circumferential surface area 33 of each pipe section 22(1)-22(4). The ribbed exterior advantageously increases the strength of the length of pipe 20 to give it the ability to handle high pressure. For example, the length of pipe may be configured to withstand pressure up to 200-250 PSI.

The pattern of ribbing 50 on the exterior of each pipe section 22(1)-22(4) includes ribs 52 forming a grid pattern that defines a pocketed design. In the illustrated embodiment, the ribs 52 intersect one another at 0 and 90 degrees to provide a rectangular shaped grid pattern, and cover a majority of the exterior surface of each pipe section 22(1)-22(4). A thickness of each pipe section 22(1)-22(4) may be in a range of about 0.5 to 1 inches, and a height of the ribs may be in a range of about 1 to 2 inches, for example.

The ribbed and pocketed exterior is optimized to provide a superior strength to weight ratio. As the thickness of each pipe section 22(1)-22(4) increases and/or the height of the ribs 52 increase, then the pressure that the length of pipe 20 can withstand also increases, as readily appreciated buy those skilled in the art. The grid pattern 50 advantageously gives the pipe the ability to handle higher pressures than a pipe of a similar thermoplastic material.

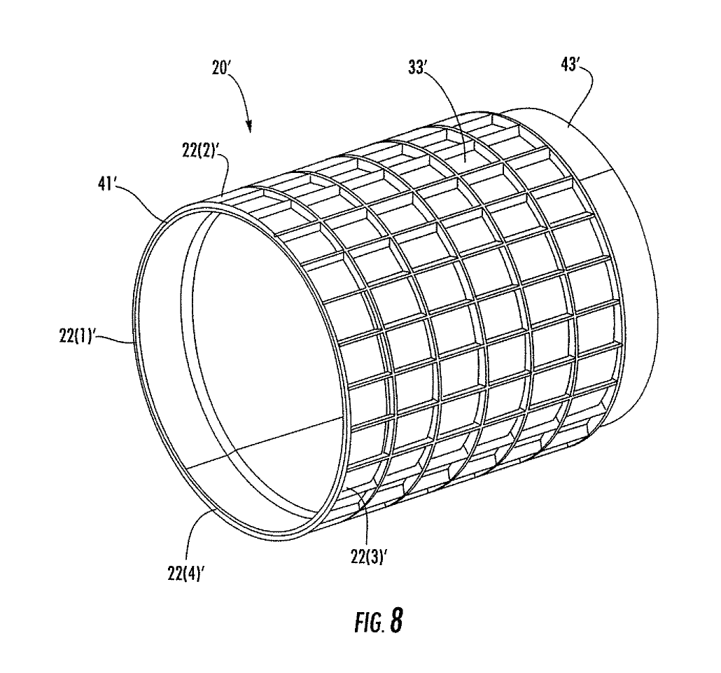

As an alternative to the ribs 52 intersecting one another at 0 and 90 degrees, ribs may also be placed within the grid pattern 50 itself to further increase the strength of the length of pipe 20. For example, a rib 54 diagonally intersects each grid pattern 50 to provide a triangular shaped grid pattern, as illustrated in FIG. 5. An additional rib 56 may be added to diagonally intersect each grid pattern 50 to provide a multiple-triangular shaped grid pattern, as illustrated in FIG. 6.

The illustrated length of pipe 20 is a large diameter length of pipe made from four identical pipe sections 22(1)-22(4) joined together along interlocking joints 30 that longitudinally extend along the length of the pipe. When the four pipe sections 22(1)-22(4) are joined together the length of pipe 20 will feature a smooth interior finish for the uninterrupted flow of liquid or gas.

Each pipe section 22(1)-22(4) may be formed out of a molding material comprising a thermoplastic material or a thermosetting material, as readily appreciated by those skilled in the art. The molding material may be based on a polymer or elastomer. The polymers may also be fiber-reinforced.

In forming each pipe section 22(1)-22(4), an extrusion compression, such as a TPF process, may be used to deliver a dynamically controlled layer of material directly to a mold as it is extruded. This process is a fast and cost-effective way to mold large thermoformed products with a one-step operation directly from an extruder.

The multi-section length of pipe 20 allows the pipe sections 22(1)-22(4) to be stacked one on top of another when shipped. When the pipe sections 22(1)-22(4) are stacked the shipping density per truckload is significantly increased as compared to unitary lengths of pipes. Nonetheless, the lengths of pipes 20 could be assembled at the factory and shipped to the installation location.

Dimensions on the diameter and length of pipe 20 will vary based on the intended application as well as the preferred method of shipping. Example diameters of the length of pipe 20 are within a range of about 2 to 10 feet. Example lengths of the length of pipe 20 are within a range of about 4 to 14 feet. The lengths may also vary based on the size of the truck or shipping container used to ship the pipe sections 22(1)-22(4).

Even though the length of pipe 20 is formed with 4 pipe sections 22(1)-22(4), a different number of pipe sections may be used. In one embodiment, the number of pipe sections is an even number since 2 half-hemisphere are eventually formed as discussed above. For example, 2, 6 or even 8 pipe sections may be used to form the length of pipe 20. The number of pipe sections used depends on the diameter of the length of pipe 20, with a larger diameter typically using more pipe sections for ease of assembly. In another embodiment, one of the half-hemispheres is formed by a single unitary pipe section, whereas the other half-hemisphere is formed by an even number of pipe sections.

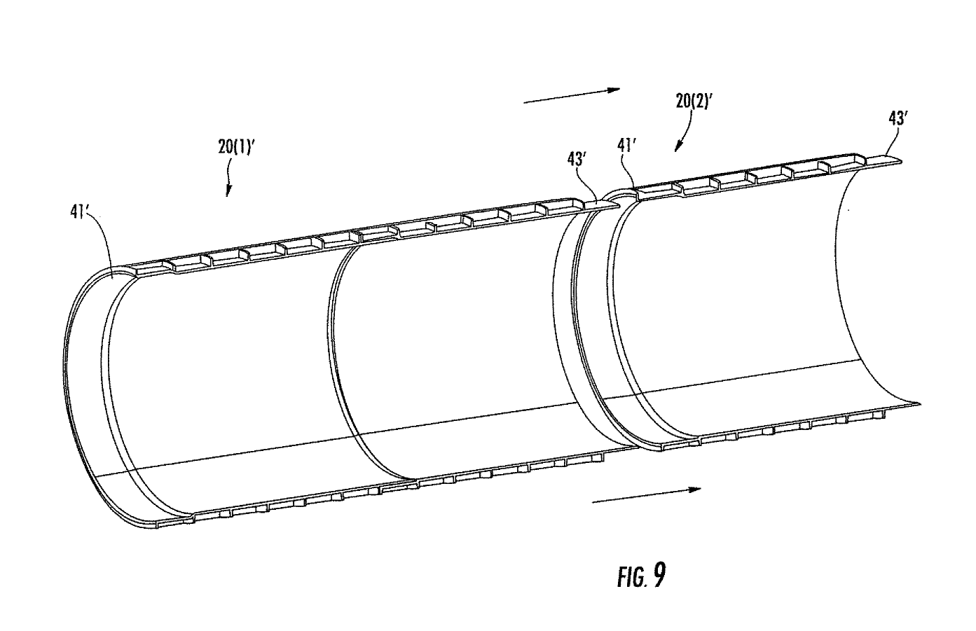

In the illustrated embodiment, each pipe section 22(1)-22(4) further includes a pair of opposing end areas 41, 43, with the radially outward circumferential surface area 33 extending between the pair of opposing end areas. In one embodiment, each end area 41, 43 includes a flange 60 and reinforced ribbing 62 adjacent the flange, with the ribbing circumferentially extending along an exterior surface 45, 47 of the end area adjacent the flange 60. The reinforced ribbing 62 is adjacent the pattern of ribbing 50. Completed lengths of pipe 20 can be joined together using the flanges 60 and an o-ring 70 with mechanical fasteners 72, as illustrated in FIG. 7. The o-ring 70 fits within a grove 74 that circumferentially extends around the outermost surface of each flange, as best illustrated in FIG. 1.

Once assembled, the lengths of pipes 20 are able to resist both acid and base liquids that may be at high pressure and high temperatures. Pressure may reach as high as 200-250 PSI and the temperatures may reach as high as 200-300° F., for example. Since the lengths of pipes 20 are formed from polymers, they are recyclable and non-corrosive. The lengths of pipes 20 provide stiffness, have a high elongation break resistance for earth movement, as well as reducing pipe movement in the soil due to the locking features of the rib pockets 50.

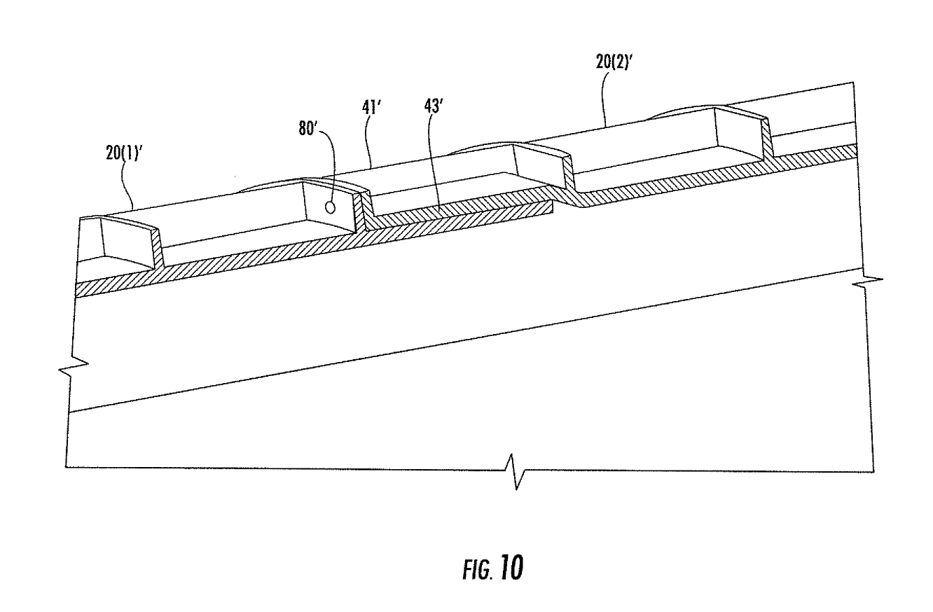

As an alternative to forming the length of pipe 20 with flanges 60 for joining with other length of pipes, a bell end and slip fit end design may be used, as illustrated in FIG. 8. In this embodiment, each pipe section 22(1)′-22(4)′ further includes a pair of opposing end areas 41′, 43′, with the radially outward circumferential surface area 33′ extending between the pair of opposing end areas. One of the end areas 43′ is configured as a slip fit end and the other end area 41′ configured as a bell end, with the slip fit end having a radius less than a radius of the bell end. With this design, the bell end 41′ of the length of pipe 20′ is larger than the slip fit end 43′. The slip fit end 43′ is intended to fit into the bell end 41′ of an adjacent pipe, as illustrated in FIG. 9.

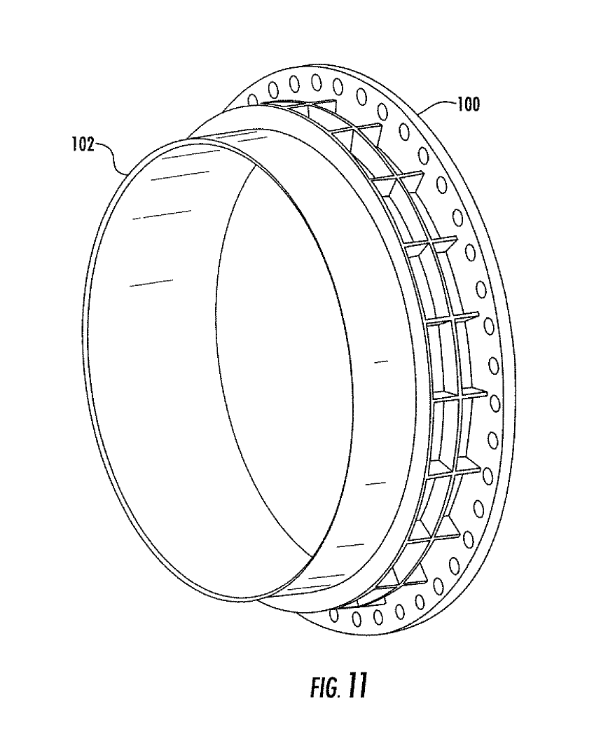

A solvent glue or adhesive may be used between the slip fit end 43′ and the bell end 41′ to ensure that the joined together lengths of pipes 20(1)′, 20(2)′ are watertight. In addition, once two lengths of pipes 20(1)′, 20(2)′ are jointed together, mechanical fasteners 80′ may be added to further strengthen the connection, as illustrated in FIG. 10. The mechanical fasteners 80′ maybe rivets or bolts, for example.

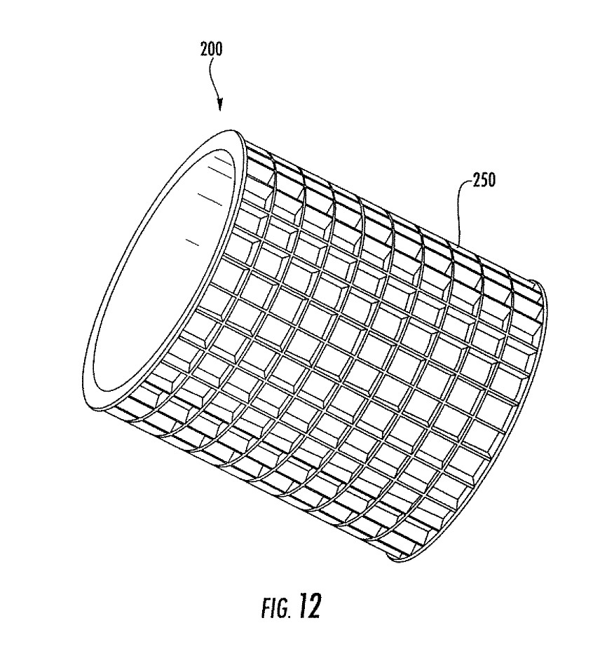

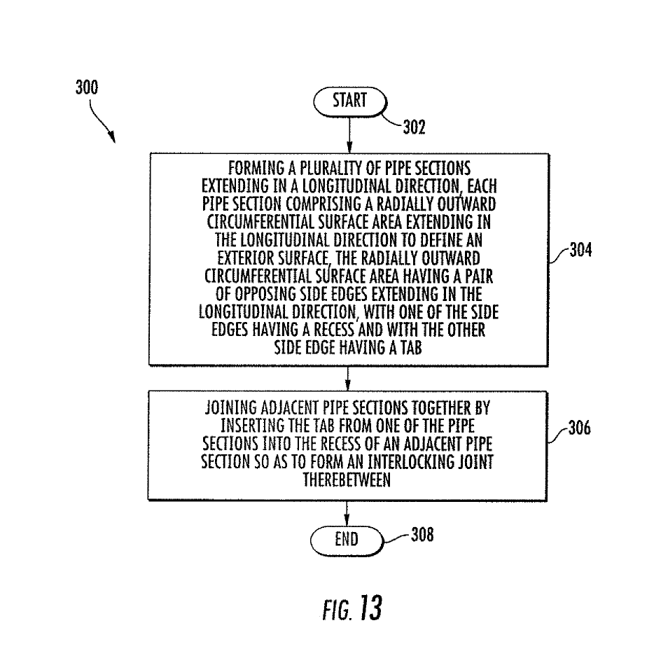

Referring now to FIG. 11, the illustrated adaptive coupler 100 is used to make a connection for the end length of pipe 20 in an installation. The adaptive coupler 100 is compatible with either the flanged pipe design 20 as illustrated in FIG. 1 or the bell end and slip fit end design 20′ as illustrated in FIG. 8.

The adaptive coupler 100 includes a slip fit end 102 to fit within a shortened length of pipe 20, 20′. The shortened length of pipe 20, 20′ acts as a bell end to receive the slip fit end 102. A solvent glue or adhesive may be used between the slip fit end 102 and the bell end 21′ to ensure that the joined adaptive coupler 100 is watertight.

Yet another embodiment is directed to a length of pipe 200 as illustrated in FIG. 1 formed as a unitary piece. There are no linear seams in this embodiment. An internal mandrel is used to form the unitary length of pipe 200, as readily appreciated by those skilled in the art.

This length of pipe 200 is shorter, and may typically be about 5 feet in length, for example. The unitary length of pipe 200 has a smooth interior finish for the uninterrupted flow of liquid or gas with a ribbed exterior 250 to increase the strength of the pipe to give it the ability to handle high pressure. The ribbing pattern 250 is similar to the ribbing 50 illustrated in FIG. 1.

The ribbed and pocketed exterior is optimized to provide a superior strength to weight ratio. The pockets can be of varying sizes to produce the different results. The length of pipe 200 is similar to the length of pipes as discussed above and will not be discussed in detail.

Referring now to the flowchart 300 illustrated in FIG. 13, a method for making the pipe 20 comprises from the start (Block 302), forming a plurality of pipe sections 22(1)-22(4) extending in a longitudinal direction at Block 304. Each pipe section 22(1)-22(4) includes a radially outward circumferential surface area extending in the longitudinal direction to define an exterior surface. The radially outward circumferential surface area has a pair of opposing side edges 30, 32 extending in the longitudinal direction, with one of the side edges having a recess 34 and with the other side edge having a tab 38. The method further comprises joining adjacent pipe sections together at Block 306 by inserting the tab 38 from one of the pipe sections 22(1)-22(4) into the recess 34 of an adjacent pipe section so as to form an interlocking joint 30 therebetween. The method ends at Block 308.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed:

1. A pipe comprising:
a plurality of pipe sections extending in a longitudinal direction, each pipe section comprising
a radially outward circumferential surface area extending in the longitudinal direction to define an exterior surface, the radially outward circumferential surface area having a pair of opposing side edges extending in the longitudinal direction, with one of the side edges having a recess and with the other side edge having a tab; and
adjacent pipe sections being joined together by inserting the tab from one of the pipe sections into the recess of an adjacent pipe section so as to form an interlocking joint therebetween.

2. The pipe according to claim 1 wherein the recess and tab on the respective opposing side edges of each pipe section are positioned along an interior surface of each pipe section.

3. The pipe according to claim 1 further comprising ribbing that circumferentially extends along the exterior surface of each pipe section.

4. The pipe according to claim 3 wherein the ribbing forms a rectangular-shaped grid pattern.

5. The pipe according to claim 3 wherein the ribbing forms a triangular-shaped grid pattern.

6. The pipe according to claim 1 wherein each side edge includes a plurality of openings extending therethrough, with the plurality of openings between adjacent pipe sections forming the interlocking joint being aligned with one another; and further comprising a plurality of mechanical fasteners extending through the plurality of openings.

7. The pipe according to claim 6 wherein said plurality of mechanical fasteners comprises at least one of rivets, and nuts and bolts.

8. The pipe according to claim 1 wherein each pipe section further comprises a pair of opposing end areas, with the radially outward circumferential surface area extending between the pair of opposing end areas, each end area comprising a flange and ribbing adjacent the flange, with the ribbing circumferentially extending along an exterior surface of the end area adjacent the flange.

9. The pipe according to claim 1 wherein each pipe section further comprises a pair of opposing end areas, with the radially outward circumferential surface area extending between the pair of opposing end areas, with one of the end areas configured as a slip fit end and the other end area configured as a bell end, with the slip fit end having a radius less than a radius of the bell end.

10. The pipe according to claim 1 wherein said plurality of pipe sections comprises at least one of 2, 4, 6 and 8 pipe sections.

11. The pipe according to claim 1 wherein each pipe section comprises a thermoplastic material.

12. The pipe according to claim 1 wherein each pipe section comprises a thermosetting material.

13. A pipe comprising:
a plurality of pipe sections extending in a longitudinal direction, each pipe section comprising
a radially outward circumferential surface area extending in the longitudinal direction to define an exterior surface, the radially outward circumferential surface area having a pair of opposing side edges extending in the longitudinal direction, with one of the side edges having a recess and with the other side edge having a tab each positioned along an interior surface of each pipe section, and
ribbing that circumferentially extends along the exterior surface of each pipe section; and
adjacent pipe sections being joined together by inserting the tab from one of the pipe sections into the recess of an adjacent pipe section so as to form an interlocking joint therebetween.

14. The pipe according to claim 13 wherein the ribbing forms at least one of a rectangular-shaped grid pattern and a triangular-shaped grid pattern.

15. The pipe according to claim 13 wherein each side edge includes a plurality of openings extending therethrough, with the plurality of openings between adjacent pipe sections forming the interlocking joint being aligned with one another; and further comprising a plurality of mechanical fasteners extending through the plurality of openings.

16. The pipe according to claim 13 wherein each pipe section comprises at least one of a thermoplastic material and a thermosetting material.

17. A method for making a pipe comprising:
forming a plurality of pipe sections extending in a longitudinal direction, each pipe section comprising a radially outward circumferential surface area extending in the longitudinal direction to define an exterior surface, the radially outward circumferential surface area having a pair of opposing side edges extending in the longitudinal direction, with one of the side edges having a recess and with the other side edge having a tab; and
joining adjacent pipe sections together by inserting the tab from one of the pipe sections into the recess of an adjacent pipe section so as to form an interlocking joint therebetween.

18. The method according to claim 17 wherein forming each pipe section comprises forming the recess and tab on the respective opposing side edges of each pipe section along an interior surface of each pipe section.

19. The method according to claim 17 wherein forming each pipe section further comprises forming ribbing that circumferentially extends along the exterior surface of each pipe section.

20. The method according to claim 19 wherein the ribbing forms at least one of a rectangular-shaped grid pattern and a triangular-shaped grid pattern.

21. The method according to claim 17 wherein each side edge includes a plurality of openings extending therethrough, with the plurality of openings between adjacent pipe sections forming the interlocking joint being aligned with one another; and joining the adjacent pipe sections further comprises positioning a plurality of mechanical fasteners through the plurality of openings.

22. The method according to claim 17 wherein forming each pipe section further comprises forming a pair of opposing end areas, with the radially outward circumferential surface area extending between the pair of opposing end areas, each end area comprising a flange and ribbing adjacent the flange, with the ribbing circumferentially extending along an exterior surface of the end area adjacent the flange.

23. The method according to claim 17 wherein forming each pipe section further comprises forming a pair of opposing end areas, with the radially outward circumferential surface area extending between the pair of opposing end areas, with one of the end areas configured as a slip fit end and the other end area configured as a bell end, with the slip fit end having a radius less than a radius of the bell end.

24. The method according to claim 17 wherein each pipe section comprises a thermoplastic material.

25. The method according to claim 17 wherein each pipe section comprises a thermosetting material.
